(19) United States
(12) Patent Application Publication
(10) Pub. No.: US 2010/0239839 A1
(43) Pub. Date: Sep. 23, 2010

(54) CONTINUOUS FILAMENT TOW FOR FIBER BATTS

(75) Inventor: Carol Lynn Barnes-Limberg, Statesville, NC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: Invista North America S.A.R.L, Wilmington (US)

(21) Appl. No.: 12/530,597

(22) PCT Filed: Mar. 5, 2008
(86) PCT No.: PCT/US2008/055883

§ 371 Date: May 7, 2010

Related U.S. Application Data
(60) Provisional application No. 60/906,093, filed on Mar. 9, 2007.

(51) Int. Cl. D04H 13/00; D02G 3/00; B29C 47/00; B65B 13/20

(52) U.S. Cl. 428/292.1; 428/364; 428/378; 264/211.12; 53/428

(57) ABSTRACT

The present invention relates to a continuous filament tow, for use as a filament batt in insulating materials, comprising a continuous solid filament and a continuous hollow filament. The filament batt made from the continuous filament tow has improved compressibility and recovery compared to crimped fiber batts made from a single filament or a single denier. The present invention also includes articles comprising such filament batts and a process by which the continuous filament tow is produced.

This application is a 371 of International Application Number PCT/US2008/066883 filed Mar. 5, 2008 and in turn claims the benefit of U.S. Provisional Application No. 60/906,093 filed Mar. 9, 2007.

### FIELD OF THE INVENTION

The present invention relates to a continuous filament tow, for use as a batt in insulating materials, that provides improved compressibility and recovery.

### BACKGROUND OF THE INVENTION

Continuous filament bonded batts are employed as stuffing for sleeping bags, comforters, pillows, cushions, mild winter clothing, etc. The continuous filament tows from which they are prepared are a solid, single denier filament. On the other hand it is also known to employ non-continuous mixed denier staple fibers (fibers of about ¼ to about 3 inches) to mimic an insulative down-feathers mix for winter clothing and sleeping bags.

Staple fibers, like down or down-feather mixes, have good recovery and compressibility features, but they shift and clump during use. The article must be fluffed-up to more evenly redistribute the fibers to provide a more uniform insulative value. A significant advantage of a continuous filament tow is that the resulting fiber batt has a high degree of mechanical integrity. This aids in the assembly of sleeping bags and insulting clothing by eliminating cold spots that usually exist during quilting. Unfortunately, a typical continuous filament batt does not have the good recovery and compressibility features of the staple fibers.

Accordingly there is a need in the market place for an insulative continuous filament batt that has excellent recovery and compressibility features

### SUMMARY OF THE INVENTION

In accordance with the present invention, it has now been found that a blend of solid and hollow continuous filaments used in making insulative continuous filament batts improve the recovery and compressibility features of those batts. The present invention relates to a continuous filament tow comprising a continuous solid filament and a continuous hollow filament. This invention also encompasses filament batts and articles made from this composition and a process by which the continuous filament tow is produced.

### DETAILED DESCRIPTION OF THE INVENTION

The present invention can be characterized by a continuous filament tow comprising a continuous solid filament and a continuous hollow filament. The hollow filament can have a void content of from about 10% to about 50%, for example from about 20% to about 40% or from about 25% to about 35%. The solid filament can have a denier of from about 1 to about 2, for example from about 1 to about 1.75 or about 1 to about 1.5. The hollow filament can have a denier of from about 1 to about 3, for example from about 1.2 to about 2.5 or about 1.5 to about 2.25. The solid filament can be present in a concentration of from 5 weight % to 95 weight %, for example from 30 weight % to 70 weight % or suitably about 50 weight %. The hollow filament can be present in a concentration of from 5 weight % to 95 weight %, for example from 30 weight % to 70 weight % or suitably about 50 weight %. The present invention includes a continuous filament tow comprising: a) 30 to 70 wt. % of a continuous solid filament having a denier of about 1 to about 1.5, and b) 70 to 30 wt. % of a continuous hollow filament having a denier of about 1.5 to about 2.25; optionally, wherein the hollow filament has a void content of from about 25% to about 35%.

The filaments of the present invention can be the same or different in cross-sectional shape, such as round, oblong, dog-bone, rectangular, triangular, gear-teeth, or flat. Furthermore the filaments can be coated, with a slick finish to reduce the friction when the filaments contact one another.

The present invention also includes a batt comprising a continuous filament tow comprising a continuous solid filament and a continuous hollow filament. The batt can be bonded or unbonded. The batt can be chemically bonded using acrylic based latex emulsions or thermally bonded using binder fibers or hot melt adhesives.

The present invention also includes articles made from the above batts, for example sleeping bags, comforters, pillows, mild winter clothing, cushions, etc. The batt for sleeping bags must have a high insulation value, measured in clo units. The batt of the present invention typically has an insulative value of at least 1.5 clo/ounce. The weight of the batt (ounce) being that of a 20″×20″ square of the batt. In addition a batt for sleeping bags typically compresses to a small size for packing, corresponding to at least a percent compression of about 85 or greater, and typically recovers at least about 85% of its initial thickness to achieve its insulation value.

The various continuous filaments for the present invention can be produced from polyester. Continuous filaments, by definition, have extreme or indefinite length, such as silk filament. Polyester filaments typically include those produced from polyethylene terephthalate (PET), polybutylene terephthalate, polypropylene terephthalate, poly(1,4 cyclohexylene-dimethylene) terephthalate, polyethylene naphthalate, polyethylene bibenzoate, copolyesters of these, as well as others known to those skilled in the art.

The present invention further includes a process comprising the steps of combining or spinning sub-tows having similar natural draw ratios, drawing a mixture of these spun sub-tows, crimping and packing the continuous tow. For example, a process for preparing a continuous filament tow comprising a mixture of solid filaments and hollow filaments, said process comprising: (a) melting a polyester polymer; (b) extruding said molten polymer: i) through a spinneret and quenching to form a sub-tow of solid filaments having a natural draw ratio between about 2 and about 5, and ii) through another spinneret and quenching to form a sub-tow of hollow filaments having a natural draw ratio between about 2 and about 5; (c) combining a mixture of said sub-tows from step b)i) and b)ii) wherein said sub-tows have about the same average, within a range of about 0.2, natural draw ratio; and (d) drawing said mixture of said sub-tows to form a continuous filament tow. Optionally, additional step (e) can include heat setting, crimping, drying and packing the continuous filament tow.

Generally, the method of making polyester is known and the production of filaments is as follows. Molten polyester is extruded from a spinneret and cooled or solidified. These filaments are then grouped together with other filaments extruding from other spinnerets and combined to form a sub-tow. A suitable natural draw ratio of the sub-tow is in the range of about 2 to about 5. Suitable filaments have an I.V. of about 0.62 (ASTM D4603-92). Filaments having a denier within the range of about 1 to about 5 are suitable in the present invention. The fibers may be of any cross-sectional shape, such as round, flat, oval, triangular, rectangular, oblong, dog-bone, gear-teeth, Y-shaped, or a combination of these features, etc.

These filaments are blended together by creeling the cans of sub-tows of each denier type desired, one of which is hollow. The sub-tows should have about the same natural draw ratio, for example within a range of about 0.2 of the average, in order for them to be drawn to the same draw ratio. Blends with a natural draw ratio outside this range will not draw uniformly causing broken filaments, fused filaments and the like. In order to obtain a good uniform mixture, the sub-tows tows can be alternated in the creel such that the sub-tows are well dispersed in final spun yarn tow. This spun yarn tow is drawn, and heat set on a conventional staple fiber drawing line, crimped and dried in an oven, and,the tow packed. The filament strength is typically in the range of about 4 to 5 grams/denier, and the filament modulus is typically in the range of 1.25 to 1.75 grams/denier. Filaments can be crimped in the range of 8 to 20 crimps per inch, with a percent crimp in the range of 35 to 45. Crimping equipment is known to those skilled in the art and generally any type of commercially available crimper is acceptable. The typical finish oil on the fiber, prior to packing the tow in a box, is in the range of 0.3 to 0.5 wt. % based on the wt. of the tow. The denier of the final continuous filament tow can be about 250,000 to 350,000. The blends of the present invention are typically 40 to 60% by weight of the smaller denier solid filament and 60 to 40 wt. % of the larger hollow denier type, for example about 50:50 by weight of each denier.

If a coating is desired, the tow or filament bundle can be coated with a poly(siloxane) composition, generally immediately before or just after the crimper. The amount of coating can be about 0.3 to 1.0 wt. % based on the wt. of the filament tow. Typical compositions are aqueous based and have about 5 to 10 wt. % solids. A typical poly(siloxane) composition comprise 0.34% of aminosilane as a cross-linking agent, 3.7% by weight of a methylhydrogenpolysiloxane monomer, 2.3% by weight of a dimethyl polysiloxane monomer and a 0.66% by weight of an antistat, such as oleyl imidazolinium ethyl sulfate.

The filament tows can be spread, using a threaded roll as described in U.S. Pat. No. 3,328,850. The spread tow can be cross-lapped to the required width of the insulative batt, lightly needle punched and lightly bonded using a liquid acrylic or latex binder. Alternatively the continuous filament tow can be spread open with a threaded roll and formed into a batt suitable for pillows and cushions as described in U.S. Pat. No. 3,423,795.

### Test Procedures

1. Compression and Recovery

The tow is spread, using a threaded roll, to produce a batt with a width of 60 inches. 18 oz. of the batting is cut, rolled and placed in a 25.5×19.5 inch pillow ticking.

The thickness of the pillow under various loads is measured with a tensile tester having a pressure foot with an area of 50 sq. in. Crosshead speed is set at 24 in./minute.

The pillow is placed on the crosshead table. The crosshead is raised until the pressure foot comes in contact, with the pillow; the thickness is measured and reported as the initial loft (L₀). The crosshead is raised, and stopped for 30 seconds, at each of the following loads, 0.5, 2, 4, 10, 15, 25 and 50 lb. and the thickness measured at each load. The thickness under a load of 50 lb. (corresponding to a pressure of 1 psi) is reported as L_{c}. After 5 minutes under a load of 50 lb, the crosshead is then lowered until the pressure foot is completely clear from the pillow. After allowing the sample to relax for 5 minutes, the crosshead is raised until a load of 0.5 lb. is indicated, and the thickness measured (L₂ in.). The thickness under the initial load of 0.5 lb. (L₁ in.) is used in the calculation of % recovery, rather than the initial loft (Lₒ), to eliminate any variations in thickness due to the filling of the pillow.

The percent Compression is: (L₁−L_{c})/L₁)×100

The percent Recovery is: (L₂/L₁)×100

2. Linear Density (Denier)

The denier of the synthetic fibers was measured according to ASTM D1577-96, option A, using uncut fibers (tow). The denier per filament (DPF) is calculated from counting the number of filaments in the tow.

3. Tenacity, Modulus and Hot Air Shrinkage

The tenacity, modulus and hot air shrinkage of the tow were measured according to ASTM D3822-96. For the tenacity and modulus measurement the uncut fibers (tow) were used with a 5 inch gauge length and a strain rate of 60%/minute. The modulus is reported as the load at 10% elongation in gram/denier.

4. Crimp Frequency (Crimps Per Inch, Cpi)

The crimp frequency was measured according to ASTM D3937-94, using option one for preparing the sample.

5. Percent Crimp

A length of tow, approximately 1.25 m, is clamped at one end and tensioned to remove the crimp. The tow is cut at a distance of 1 m from the clamp, and the length of the crimped tow band is measured (L, cm). The percent (%) crimp is 100−L.

6. Natural Draw Ratio

The spun sub-tows are broken according to the procedure for measuring yarn physical properties—ASTM D3822-96. The elongation at break is recorded (E_{b}, %). The natural draw ratio is defined as 1+E_{b}/100.

7. Insulation Value

The tow is spread, using a threaded roll, to produce a batt with a width of 60 inches. Four sections of the batt are laid on top of each other and cut to a 20″×20″ square sample. The insulation value of the batting is measured using the constant temperature method specified in ASTM D 1518 and ASTM F 1868, using a sweating hot plate. The insulation value is reported in clo units, normalized to the weight of the batt (clo/ounce).

8. Hollow Filament Void Content

A section (about 20 cm) of the hollow continuous tow is cut and combed. Approximately 50 filaments are mounted in a Shirley plate and cut. An optical photomicrograph of the cut cross-section of the filaments is taken. The outside area and inside area of the hollow filament is measured with a planimeter, or optical scanning software. The % void is the (area of the hollow void/area of the filament)×100. The reported result is the average of measurements of at least 10 filaments.

### Examples

Standard polyester staple processes were used to prepare spun sub-tows, at spinning speeds in the range of about 500 meters/minute, using a polymer having an Intrinsic Viscosity of about 0.62. Ten or eleven of these sub-tows, each with a denier of about 35,000 were combined and drawn, heat set, crimped in a stuffer box and dried in an oven to produce the final tow. Finish lubricants are supplied in a pre-drawn frame bath.

In the trials in which blends of different types of fibers were used, the blends were prepared by combining different number of sub-tows, which were all drawn, heat set and crimped together on the same staple drawframe. Typical physical properties are set forth in Table 1.

TABLE 1

| | |
|---|---|
| Crimps per inch | 10 |
| Crimp, % | 40 |
| Tenacity, grams/denier | 4 to 5 |
| Modulus, grams/denier | 1.25 to 1.75 |
| Elongation, % | 40 to 45 |
| Hot Air Shrinkage, % | 4 to 5 |

### Comparative Example 1

In this trial tows were prepared from solid cross-section fibers and hollow (=30% void) cross-section fibers. The natural draw ratio of the sub-tow of run 1 was 4.15 and the natural draw ratio of the sub-tow of run 4 was 4.01. The loft and compression results are set forth in Table 2.

TABLE 2

| | Run Number | | | | |
|---|---|---|---|---|---|
| | 1 | 2 | 3 | 4 | 5 |
| Cross-section | Solid | Solid | Hollow | Hollow | Hollow |
| Denier per | 1.5 | 3 | 3.5 | 2.25 | 1.8 |
| filament | | | | | |
| L₀, inch | 8.9 | 8.5 | 8.3 | 8.3 | 7.8 |
| L₁, inch | 8.3 | 8.1 | 7.7 | 7.9 | 7.4 |
| Compression, % | 85 | 87 | 78 | 87 | 89 |
| Recovery, % | 89 | 89 | 93 | 89 | 86 |

The 1.5 dpf filament had poor initial loft due to the packing of these small diameter filaments.

### Example 2

In this trial tows were prepared from blends (50/50 wt. %) of solid and hollow (˜30% void) fibers. The results are set forth in Table 3.

TABLE 3

Run Number

| | 6 | 7 |
|---|---|---|
| Solid dpf | 1.5 | 1.5 |
| Hollow dpf | 3.5 | 2.25 |
| L₁, inch | 8.0 | 8.1 |
| Compression, % | 86 | 87 |
| Recovery, % | 93 | 92 |

The unbonded batts prepared from both blends containing hollow filaments had a superior balance of compression and recovery than the batts made from the individual filament tows.

### Example 3

In this trial a siloxane based finish was applied after the crimper and cured at 160° C. in the drying oven for about 10 minutes. The results of this slicker finish, compared with the standard finish, using a 1.5 denier solid filament and a 2.25 dpf hollow filament is set forth in Table 4.

TABLE 4

Run Number

| | 8 | 9 | 10 | 11 |
|---|---|---|---|---|
| Cross-section | Solid | Solid | Hollow | Hollow |
| Denier per filament | 1.5 | 1.5 | 2.25 | 2.25 |
| Finish | standard | siloxane | standard | siloxane |
| L₁, inch | 8.3 | 6.9 | 7.9 | 8.5 |
| Compression, % | 88 | 89 | 87 | 87 |
| Recovery, % | 85 | 85 | 89 | 89 |

The siloxane finish improved the initial loft of the 2.25 dpf hollow filament.

### Example 4

The insulation values of four of the runs reported in the previous Examples were measured and the results set forth in Table 5, together with the compression and recovery properties of the pillows made from these batts (previously recorded).

TABLE 5

| | Run Number | | | |
|---|---|---|---|---|
| | 3 | 8 | 2 | 7 |
| Cross-section | Hollow | Solid | Solid | 50/50 Solid/hollow |
| Denier per filament | 3.5 | 1.5 | 3 | 1.5/2.25 |
| L₁, inch | 7.7 | 8.3 | 8.1 | 8.1 |
| Compression, % | 78 | 88 | 87 | 87 |
| Recovery, % | 93 | 85 | 89 | 92 |
| Clo/ounce | 1.55 | 1.56 | 1.41 | 1.65 |

The 50/50 blend of the 1.5 dpf solid and 2.25 dpf hollow filaments gave an improved thermal insulation value while maintaining comparable to superior initial loft and compression and recovery to batts prepared from a single denier continuous filament tow.

Thus it is apparent that there has been provided, in accordance with the invention, a crimped continuous filament tow of mixed denier, suitable for batts to be used for sleeping bag or winter clothing that fully satisfies the aims, advantages and objects set forth above. While the invention has been described in conjunction with specific embodiments thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

1) A continuous filament tow comprising: a continuous solid filament, and a continuous hollow filament.

2) The continuous filament tow of claim 1 wherein the hollow filament has a void content of from about 10% to about 50%.

3) The continuous filament tow of claim 1 wherein the hollow filament has a void content of from about 20% to about 40%.

4) The continuous filament tow of claim 1 wherein the solid filament has a denier of from about 1 to about 2.

5) The continuous filament tow of claim 1 wherein the solid filament has a denier of from about 1 to about 1.75.

6) The continuous filament tow of claim 1 wherein the hollow filament has a denier of from about 1 to about 3.

7) The continuous filament tow of claim 1 wherein the hollow filament has a denier of from about 1.2 to about 2.5.

8) The continuous filament tow of claim 1 wherein the solid filament is present in a concentration of from 5 weight % to 95 weight %.

9) The continuous filament tow of claim 1 wherein the solid filament is present in a concentration of from 30 weight % to 70 weight %.

10) The continuous filament tow of claim 1 wherein the hollow filament is present in a concentration of from 5 weight % to 95 weight %.

11) The continuous filament tow of claim 1 wherein the hollow filament is present in a concentration of from 30 weight % to 70 weight %.

12) A continuous filament tow comprising: a) 30 to 70 wt. % of a continuous solid filament having a denier of about 1 to about 1.5, and b) 70 to 30 wt. % of a continuous hollow filament having a denier of about 1.5 to about 2.25.

13) The continuous filament tow of claim 12 wherein the hollow filament has a void content of from about 25% to about 35%.

14) The continuous filament tow of claim 1 wherein said solid filament and said hollow filament have the same or different cross sectional shape.

15) The continuous filament tow of claim 1 wherein said solid filament and said hollow filament comprise polyester.

16) The continuous filament tow of claim 15 wherein said polyester is selected from the group consisting of polyethylene terephthalate, polybutylene terephthalate, polypropylene terephthalate, poly(1,4 cyclohexylene-dimethylene) terephthalate, polyethylene naphthalate, polyethylene bibenzoate, and copolyesters of these.

17) A filament batt comprising the continuous filament tow of either claim 1 or 12.

18) The filament batt of claim 17 wherein said batt has both a compressibility and a recovery of about 85% or greater.

19) The filament batt of claim 17 wherein said batt has an insulation value greater than about 1.5 clo/ounce.

20) The filament batt of either claim 18 or 19 wherein said batt is bonded.

21) The filament batt of claim 20 wherein said batt is chemically bonded or thermally bonded.

22) The continuous filament tow of either claim 1 or 12 wherein one or both of said filament is coated with a slick finish.

23) A filament batt comprising the tow of claim 22.

24) The filament batt of claim 23 wherein said batt has both a compressibility and a recovery of about 85% or greater.

25) The filament batt of claim 23 wherein said batt has an insulation value greater than about 1.5 clo/ounce.

26) The filament batt of either claim 24 or 25 wherein said batt is bonded.

27) The filament batt of claim 26 wherein said batt is chemically bonded or thermally bonded.

28) An article comprising the filament batt of either claim 17 or 23.

29) A process for preparing a continuous filament tow comprising a mixture of solid filaments and hollow filaments, said process comprising:
a) melting a polyester polymer,
b) extruding said molten polymer
i) through a spinneret and quenching to form a sub-tow of solid filaments having a natural draw ratio between about 2 and about 5, and
ii) through another spinneret and quenching to form a sub-tow of hollow filaments having a natural draw ratio between about 2 and about 5,
c) combining a mixture of said sub-tows from step b)i) and b)ii) wherein said sub-tows have about the same average, within a range of about 0.2, natural draw ratio, and
d) drawing said mixture of said sub-tows to form a continuous filament tow.

30) The process of claim 29 further comprising:
e) heat setting, crimping, drying and packing said continuous filament tow.

31) The process of claim 30 wherein a poly(siloxane) composition is applied to said continuous filament tow prior to or after said crimping in step e).
